(19) United States
(12) Patent Application Publication
(10) Pub. No.: US 2025/0193302 A1
(43) Pub. Date: Jun. 12, 2025

(54) FOLDING COASTER STANDS FOR MOBILE PHONES

(71) Applicants: Damon VICTOR, Brooklyn, NY (US); Evan YEE, Brooklyn, NY (US); Joseph Y. LEE, Brooklyn, NY (US); James M. BEHMKE, Boston, MA (US)

(72) Inventors: Damon VICTOR, Brooklyn, NY (US); Evan YEE, Brooklyn, NY (US); Joseph Y. LEE, Brooklyn, NY (US); James M. BEHMKE, Boston, MA (US)

(21) Appl. No.: 18/965,975

(22) Filed: Dec. 2, 2024

Related U.S. Application Data
(60) Provisional application No. 63/605,117, filed on Dec. 1, 2023.
(60) Provisional application No. 63/611,603, filed on Dec. 18, 2023.

(51) Int. Cl. H04M 1/04

(52) U.S. Cl. CPC H04M 1/04

(57) ABSTRACT

The embodiments herein provide for folding coaster stands for mobile phones. In particular, the present disclosure encompasses a number of unique designs that offer users alternatives to placing their phones on unsanitary surfaces, with varying angles of display. Each design features an initially flat shape (e.g., a square, rectangular, or circular shape, similar to a standard coaster), ingeniously folding into a three-dimensional orientation through an origami-style mechanism. This transformation allows users to prop up and securely rest their mobile phones on a stable and clean surface.

### RELATED APPLICATIONS

This application claims priority to U.S. Provisional Application No. 63/605,117, filed Dec. 1, 2023, entitled FOLDING COASTER STANDS FOR MOBILE PHONES, by Damon Victor, et al., and U.S. Provisional Application No. 63/611,603, filed Dec. 18, 2023, entitled FOLDING COASTER STANDS FOR MOBILE PHONES, the contents of which are incorporated herein by reference.

### TECHNICAL FIELD

The present disclosure relates to coasters, and, more particularly, to folding coaster stands for mobile phones.

### BACKGROUND

The evolution of mobile technology has drastically transformed daily interactions, with smartphones becoming an integral part of modern life. However, the ubiquity of these devices has presented a persistent challenge-the lack of clean and secure surfaces to place phones, particularly in public environments such as bars, restaurants, and communal spaces. Users often encounter the inconvenience of placing their phones on potentially unhygienic surfaces, risking exposure to dirt, spills, or other contaminants.

Traditionally, individuals have resorted to resting their mobile devices on tabletops, counters, or bar surfaces, which may compromise the cleanliness and safety of their phones. Existing solutions, such as phone cases with stands or separate phone holders, are available but often cumbersome or impractical for on-the-go use, lacking portability or ease of use.

### SUMMARY

The present disclosure pertains to the realm of mobile phone accessories, specifically addressing the need for a hygienic and convenient solution to safeguard mobile devices in various settings. This invention revolves around a specialized hybrid coaster design fashioned from a coaster material (e.g., fiberboard, cardboard, or similar adaptable materials), intended to offer users an alternative to resting their phones on unsanitary surfaces, such as bars or other public spaces.

Specifically, various embodiments presented herein introduce a novel solution in the form of foldable cardboard or similarly adaptable materials that can transform a flat coaster into an angled stand for mobile phones. The present disclosure encompasses a number of unique designs that offer users alternatives to placing their phones on unsanitary surfaces, with varying angles of display. Each design features an initially flat shape (e.g., a square, rectangular, or circular shape, similar to a standard coaster), ingeniously folding into a three-dimensional orientation through an origami-style mechanism. This transformation allows users to prop up and securely rest their mobile phones on a stable and clean surface.

The “phone coasters” herein thus cater to the need for a hygienic and portable accessory that ensures the cleanliness and safety of mobile devices in various settings. By addressing the challenge of unclean surfaces and providing a foldable, versatile design, the embodiments herein aim to enhance user experience while using mobile phones.

The detailed description within this patent application elucidates additional features and functionalities of each design, highlighting the versatility and practicality of these coasters for safeguarding mobile devices without limiting the scope of the embodiments herein. Other embodiments of the present disclosure may be discussed in the detailed description below, and the summary above is not meant to be limiting to the scope of the invention herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates a cut/score/fold legend.

FIGS. 2A-2E illustrate a first example embodiment and uses of a folding coaster stand for mobile phones according to the present disclosure.

FIGS. 3A-3D illustrate a second example embodiment and uses of a folding coaster stand for mobile phones according to the present disclosure.

FIGS. 4A-4E illustrate a third example embodiment and uses of a folding coaster stand for mobile phones according to the present disclosure.

FIGS. 5A-5E illustrate a fourth example embodiment and uses of a folding coaster stand for mobile phones according to the present disclosure.

FIGS. 6A-6D illustrate a fifth example embodiment and uses of a folding coaster stand for mobile phones according to the present disclosure.

FIGS. 7A-7E illustrate a sixth example embodiment and uses of a folding coaster stand for mobile phones according to the present disclosure.

FIGS. 8A-8F illustrate a seventh example embodiment and uses of a folding coaster stand for mobile phones according to the present disclosure.

FIGS. 9A-9F illustrate an eighth example embodiment and uses of a folding coaster stand for mobile phones according to the present disclosure.

FIGS. 10A-10F illustrate a ninth example embodiment and uses of a folding coaster stand for mobile phones according to the present disclosure.

### DETAILED DESCRIPTION

As noted above, mobile phone users are often presented with a lack of clean and secure surfaces to place phones. Additionally, users are more often watching videos on their phones on their desks, tables, nightstands, and so on, often while eating a meal delivered to their home. There is a need, therefore, for a practical, portable, and hygienic solution. The present disclosure, therefore, provides a coaster-based accessory crafted from foldable coaster-like material (e.g., fiberboard, cardboard, or similar adaptable materials, including various plastics, multi-layered materials, rubberized materials, and various polymers). The coaster, available in various flat shapes, ingeniously folds into a three-dimensional support structure, providing a stable and clean platform for placing and propping up mobile phones, at various corresponding stand angles for viewing of the phone by the user.

By addressing the challenge of unsanitary surfaces and offering a convenient, foldable design, the phone coasters herein aim to enhance user experience and hygiene while using mobile devices in diverse settings. In particular, the present disclosure encompasses a number of distinct designs, each catering to different user preferences and environments, ensuring a versatile and practical solution for safeguarding mobile phones from unclean surfaces.

As shown in detail below, each design herein features a flat (e.g., ⅛-¼ inch thick planar surface) coaster-like shape (e.g., square, rectangular, or circular shape, though other shapes may also be used), ranging from 3×3 inches to 6×6 inches (e.g., preferably 4×4 inches to 5×5 inches), that folds into a three-dimensional orientation through an origami-style mechanism of cuts, scores, and folds. This transformation allows users to prop up and securely rest their mobile phones on a stable and clean surface. It is to be understood that the invention is not limited in its application to the details of construction and the arrangement of components described hereinafter and illustrated in the figures. Those skilled in the art will recognize that various modifications can be made without departing from the scope of the invention.

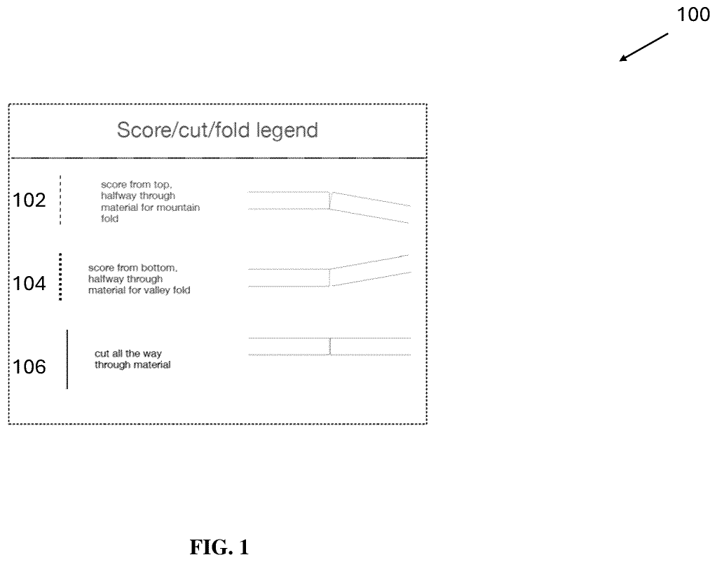

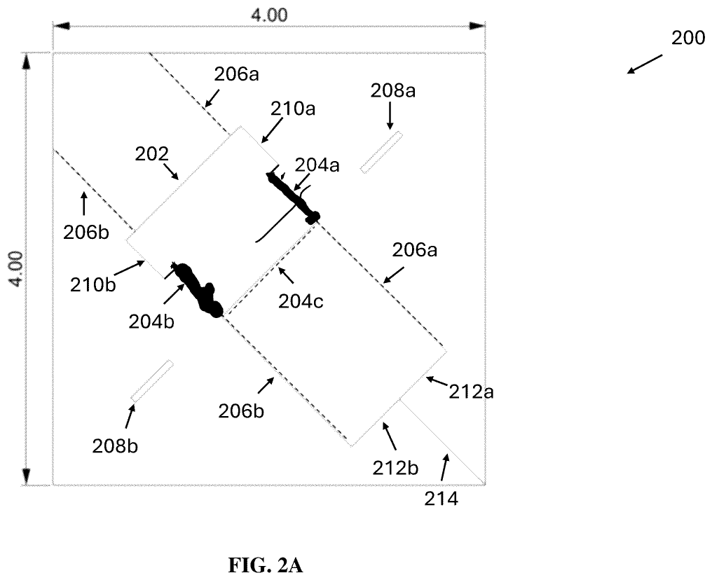

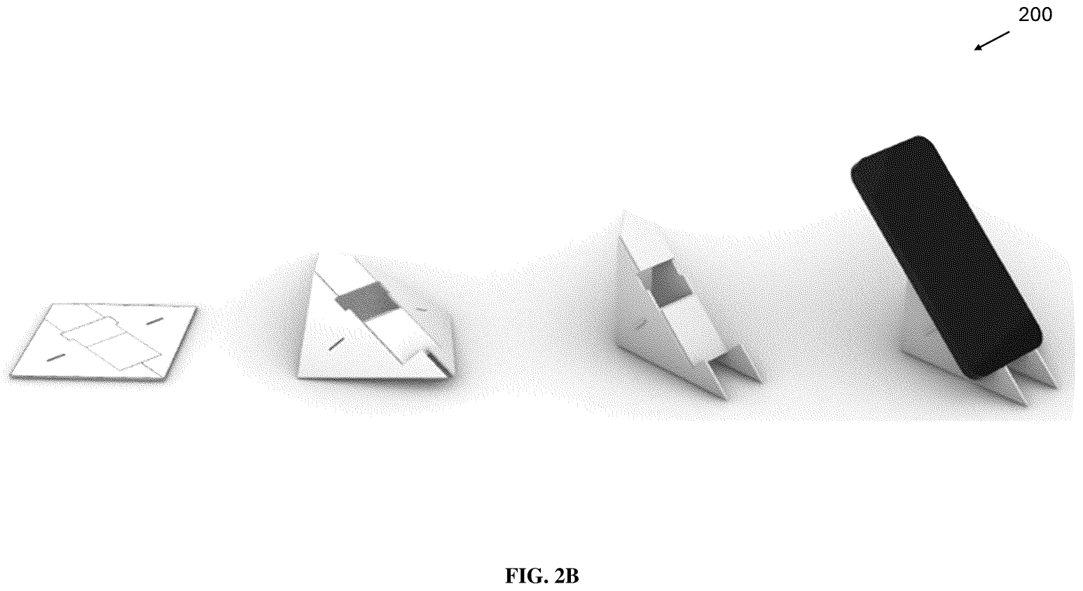

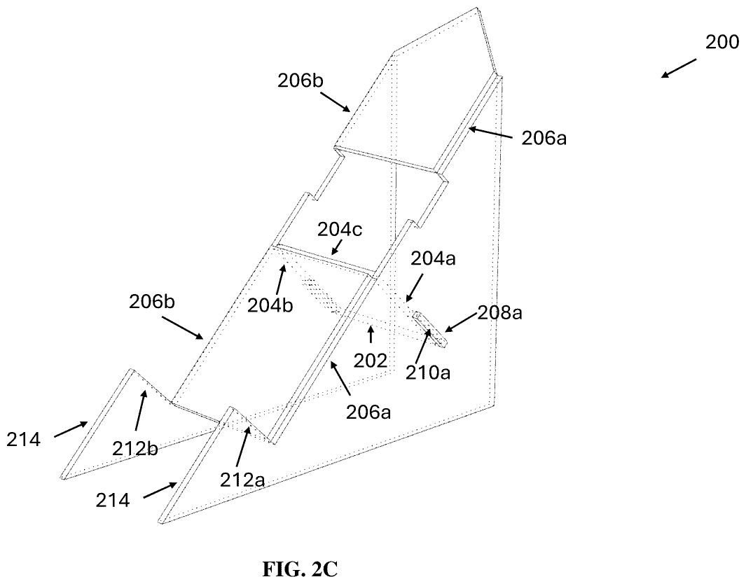

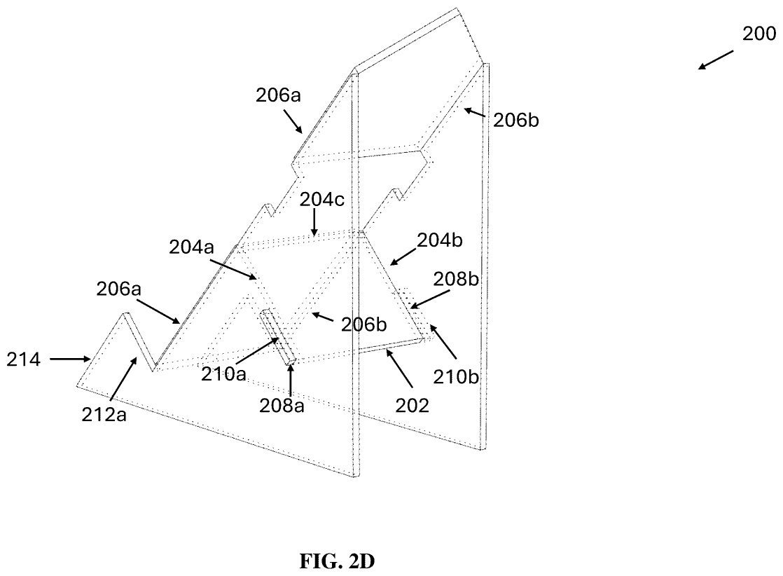

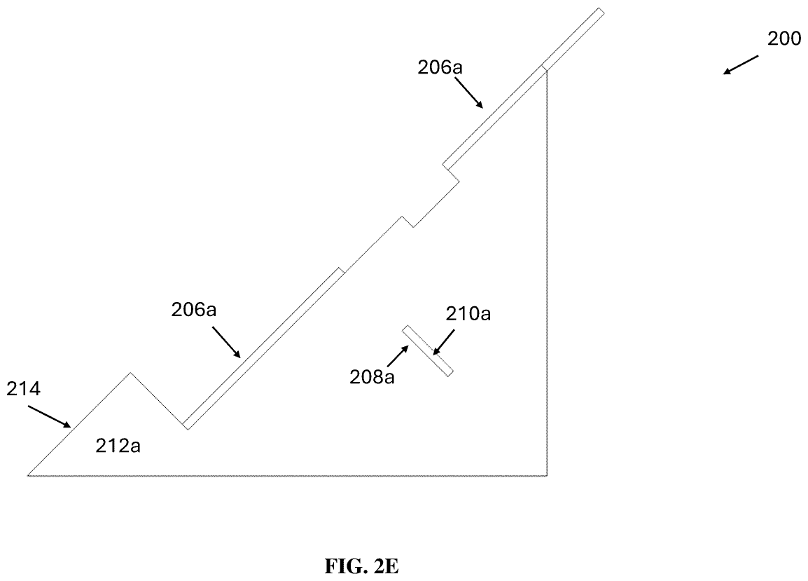

FIG. 1 shows a legend 100 for the scores and cuts on subsequent figures, where dashed lines 102 represent a score from the top halfway through the material for a mountain fold, dotted lines 104 represent a score from the bottom halfway through the material for a valley fold, and solid lines 106 represent a cut all the way through the material so that the adjoining sections can be separated. In particular, as is generally shown in FIGS. 2A-10F, a flat square or circular shaped piece of coaster material (e.g., fiberboard, cardboard, etc.), containing scores (e.g., cuts through a portion of the material) and/or cuts (e.g., fully through the material) allows folding the coaster into a three-dimensional orientation through an origami-style mechanism.

FIG. 2A shows one design 200 in its preliminary flat configuration. The dashed lines 204c 206a 206b represent a score from the top halfway through the material for a mountain fold, and solid lines 202 204a 204b 208a 208b 212a 212b 214 represent a cut all the way through the material so that the adjoining sections can be separated. The cut in the upper left quadrant 204a 204b (represented by solid lines), allows the outlined section 202 to be pushed back and away from the adjacent portions of the material, but remains connected along the dashed line on the bottom 204c (scores for folds). The parallel dashed lines 206a 206b (scores) running diagonally from the upper left to the lower right quadrant show where the material is folded in a mountain fold. The cuts in the upper right 208a and lower left 208b quadrants (shown by solid lines in the shape of a rectangle) allow for a small piece of material outlined by the cuts to be removed. The outdents 210a 210b on both sides of the cut portion (outlined in solid) in the upper left quadrant line up with the cutout sections in the upper right 208a and lower left 208b quadrant of FIG. 2A, so that when the cut section in the upper left quadrant 202 is separated from the adjacent sections and folded back, the outdents 210a 210b line up with the cut-outs in the upper right and lower left quadrants when the material is folded along the diagonal scores 206a 206b running from the upper left to bottom right quadrants. Once lined up, the outdent “tabs” 210a 210b are inserted into the cutouts 208a 208b. FIG. 2B generally shows the assembly process in four stages from left to right: the first stage is the design in its flat orientation; the second stage shows the mountain folds along the dashed lines 206a 206b (scores) and the separation of the cut section 202 from the adjoining sections along the solid lines 206a 206b 206c (cuts); the third stage shows fully folded form with the outdent “tabs” 210a 210b inserted into the corresponding cutouts 208a 208b; the fourth stage shows the product in use, with a phone resting on it. FIGS. 2C-2E show the fully assembled design, with FIG. 2C showing a front view, FIG. 2D showing a back view, and FIG. 2E showing a side view.

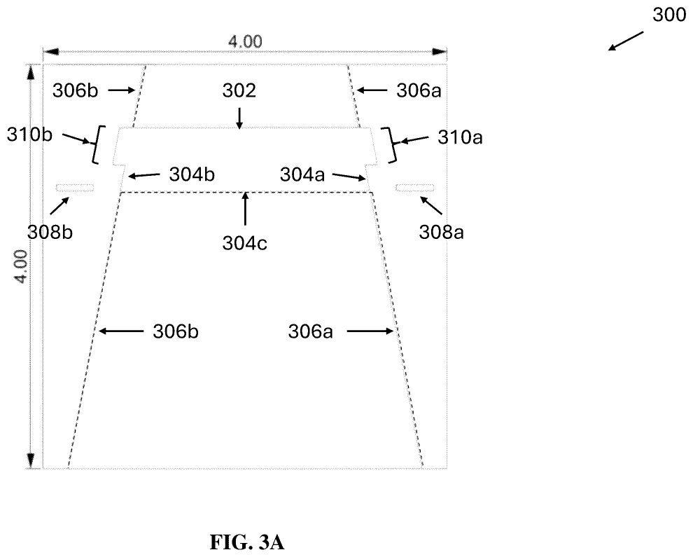

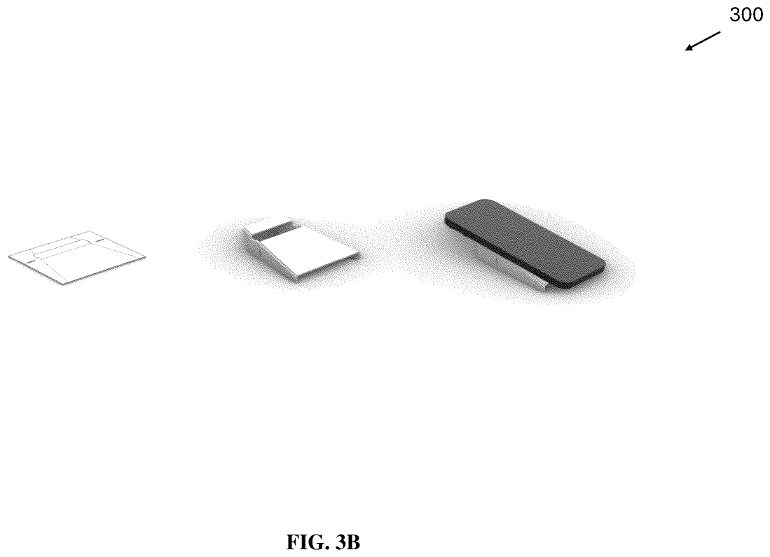

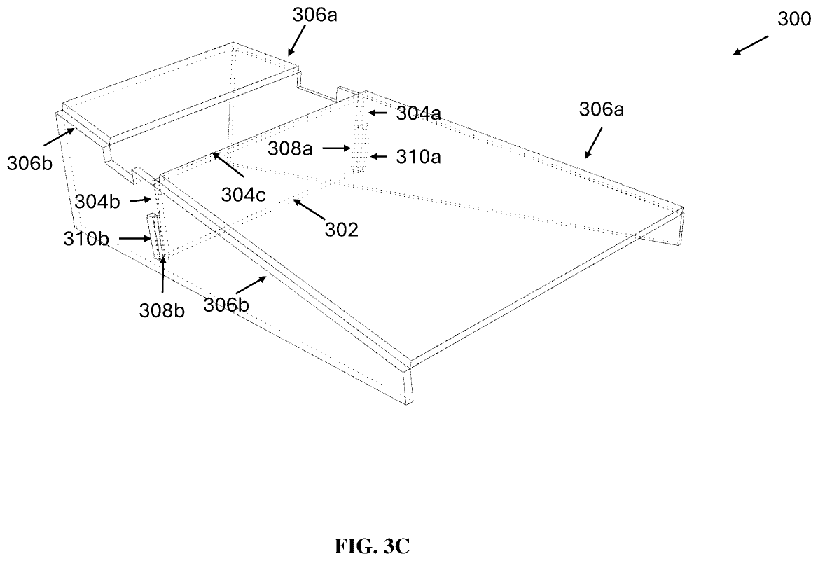

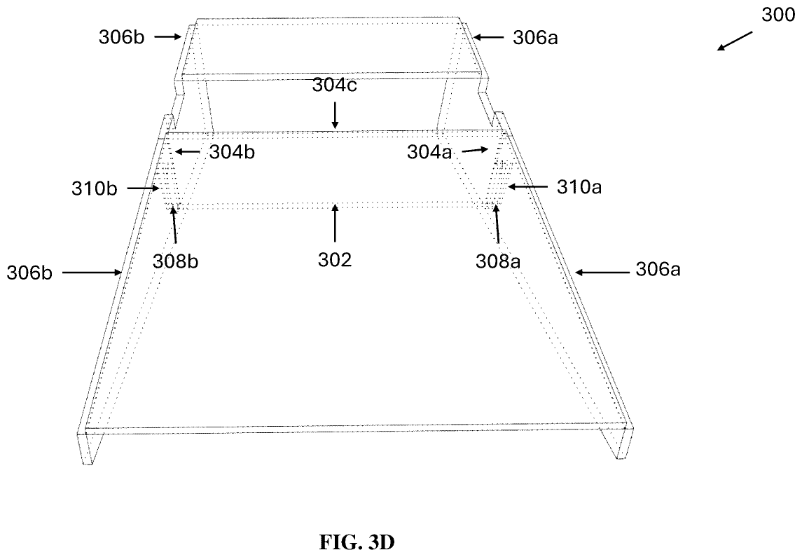

FIG. 3A shows another design 300 in its preliminary flat configuration. The dashed lines 304c 306a 306b represent a score from the top halfway through the material for a mountain fold, and solid lines 302 304a 304b 308a 308b 310a 310b represent a cut all the way through the material so that the adjoining sections can be separated. The cut in the upper mid-section (represented by solid lines), allows the outlined section 302 to be pushed back and away from the adjacent portions of the material along the cuts 302 304a 304b 310a 310b, but remains connected along the dashed line 304c on the bottom (score for fold). The diverging dashed lines 306a 306b (scores) running from top to bottom indicate where the material is folded in a mountain fold. The cuts in the upper right 308a and left 308b quadrants (shown by solid lines in the shape of a rectangle) allow for a small piece of material outlined by the cuts to be removed. The outdents 310a 310b on both sides of the cut portion (outlined in solid) in the upper mid-section line up with the cutout sections in the upper right and left quadrant of FIG. 3A, so that when the cut section 302 in the upper mid-section is separated from the adjacent sections and folded back, the outdents 310a 310b line up with the cut-outs in the upper right 308a and left 308b quadrants when the material is folded along the scores 306a 306b running vertically from top to bottom. Once lined up, the outdent “tabs” 310a 310b are inserted into the cutouts 308a 308b. FIG. 3B generally shows the assembly process in three stages from left to right: the first stage is the design in its flat orientation; the second stage shows fully folded form with the outdent “tabs” 310a 310b inserted into the corresponding cutouts 308a 308b; the third stage shows the product in use, with a phone resting on it. FIGS. 3C-3D shows the fully assembled design, with FIG. 3C showing a front left view, and FIG. 3D showing a front center view.

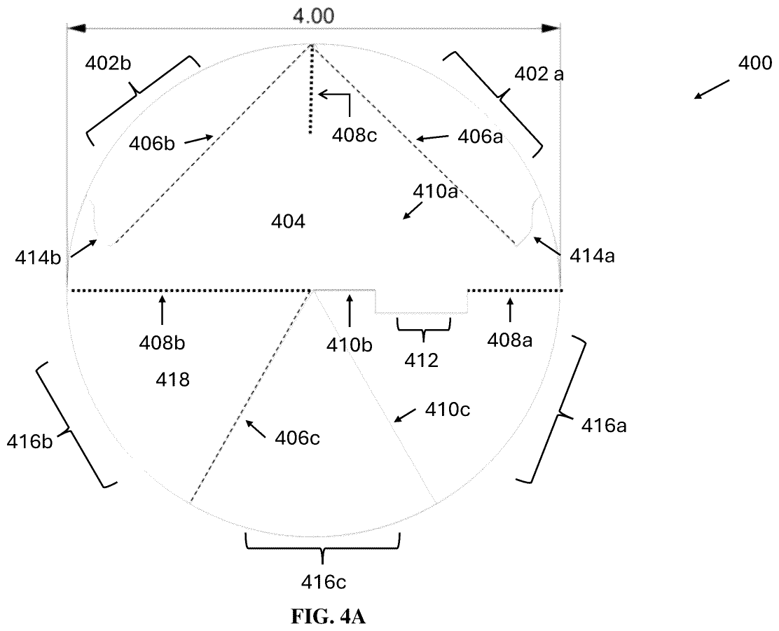

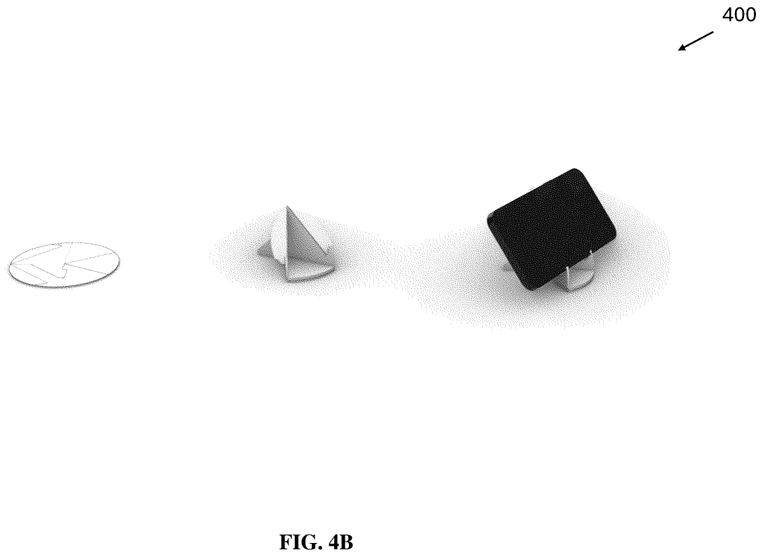

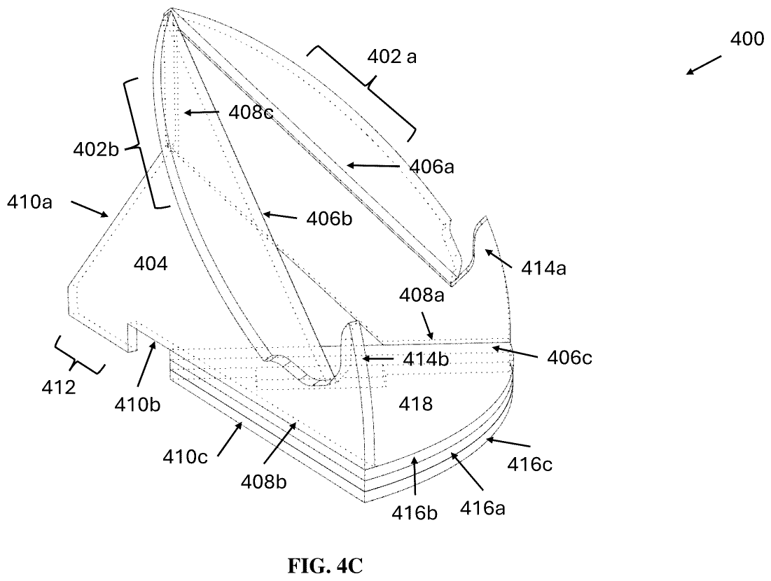

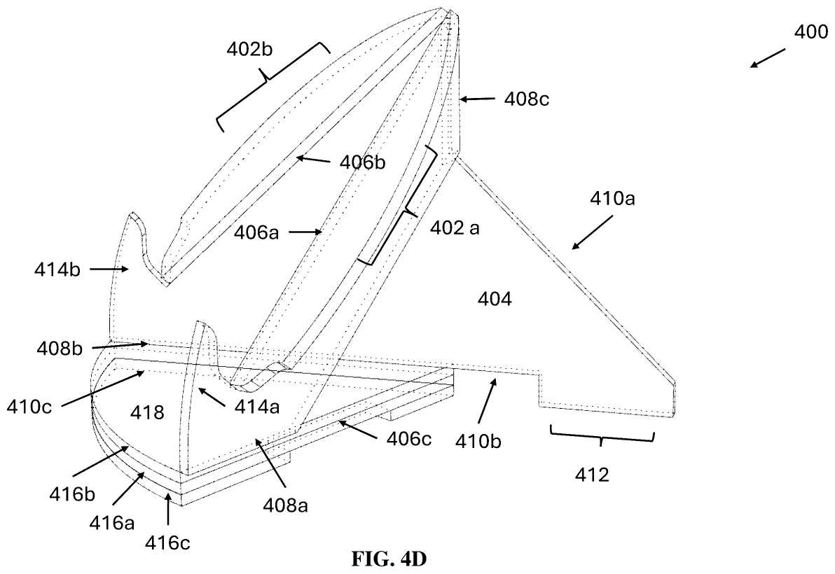

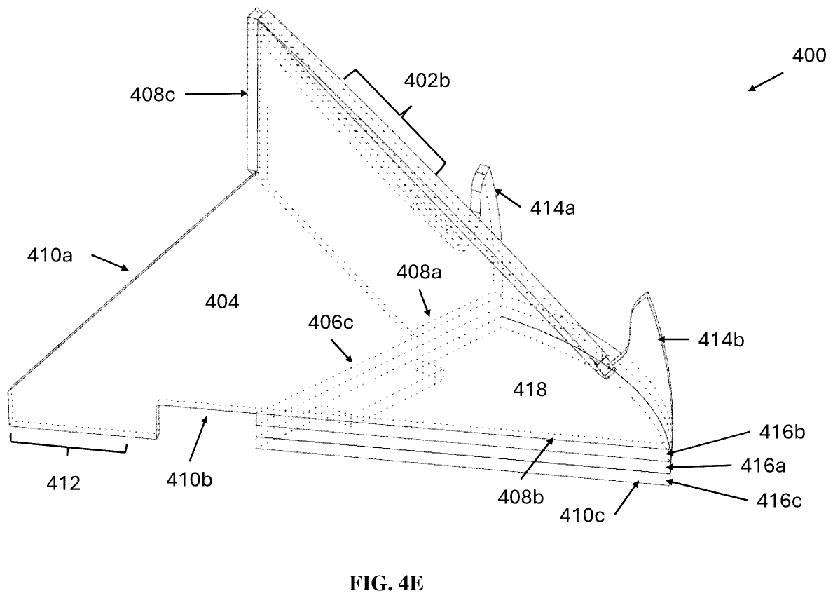

FIG. 4A shows another design 400 in its preliminary flat configuration. The dashed lines 406a 406b 406c represent a score from the top halfway through the material for a mountain fold, the dotted lines 408a 408b 408c represent a score from the bottom halfway through the material for a valley fold, and solid lines 410a 410b 410c 412 414a 414b represent a cut all the way through the material so that the adjoining sections can be separated. Similar to the other designs, the product is assembled by making the appropriate folds along the scores 406a 406b 406c 408a 408b 408c in the material and separating the material at the cuts 410a 410b 410c 412 414a 414b. When the product, in its preliminary flat orientation, is held along the upper right 402a and left rim 402b, and a perpendicular force is applied to the mid-section 404, the product easily folds along the preconfigured scores 406a 406b 406c 408a 408b 408c and cuts 410a 410b 410c 412 414a 414b in the material, such that the mid-section 404 is pushed backwards along the cut portion 410a and is propped up by an outdent 412. The general process and result is shown in FIGS. 4B-4E. FIG. 4B generally shows the assembly process in three stages from left to right: the first stage is the design in its flat orientation; the second stage shows fully folded form; the third stage shows the product in use, with the back of the phone resting against the outer rims 402a 402b and the edge of the phone being held by the hooks 414a 414b such that the phone rests above the triangular base of the holder 418 which is comprised of the three triangular layers 416a 416b 416c (shown in the bottom half of FIG. 4A) folded over each other. FIGS. 4C-4E shows the fully assembled design, with FIG. 4C showing a front left view, FIG. 4D showing a front right view, and FIG. 4E showing a left side view.

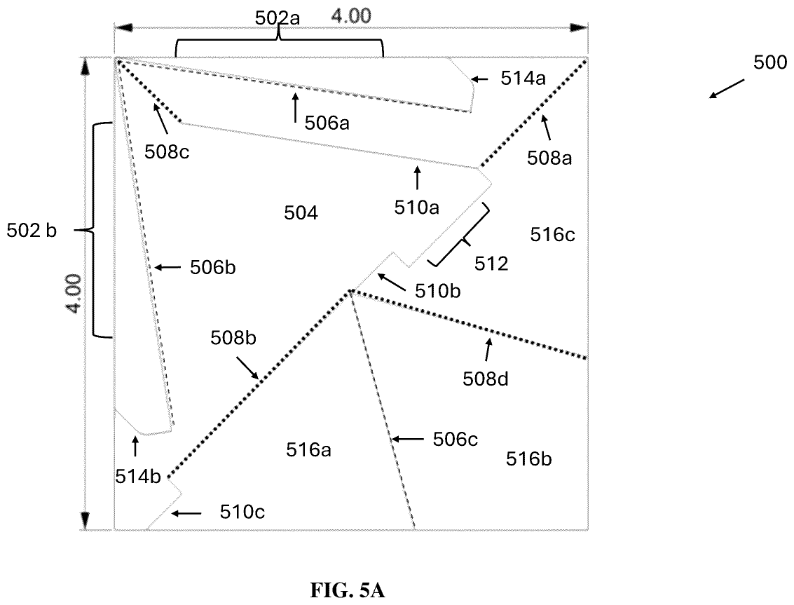

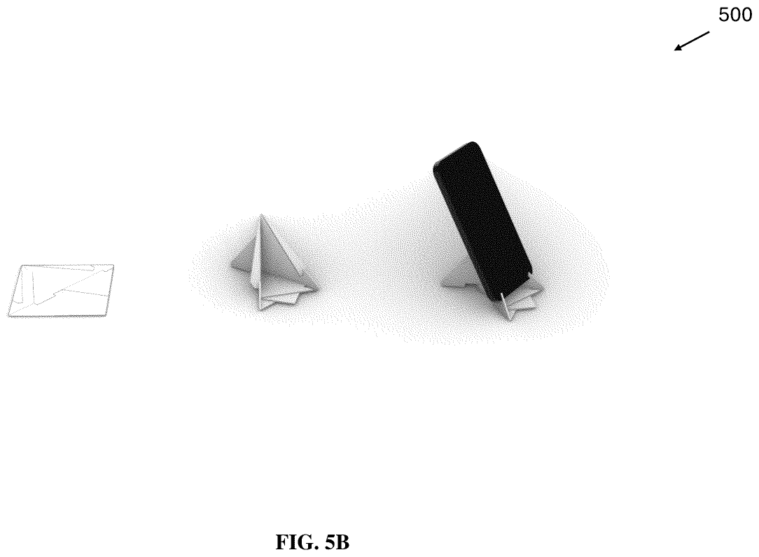

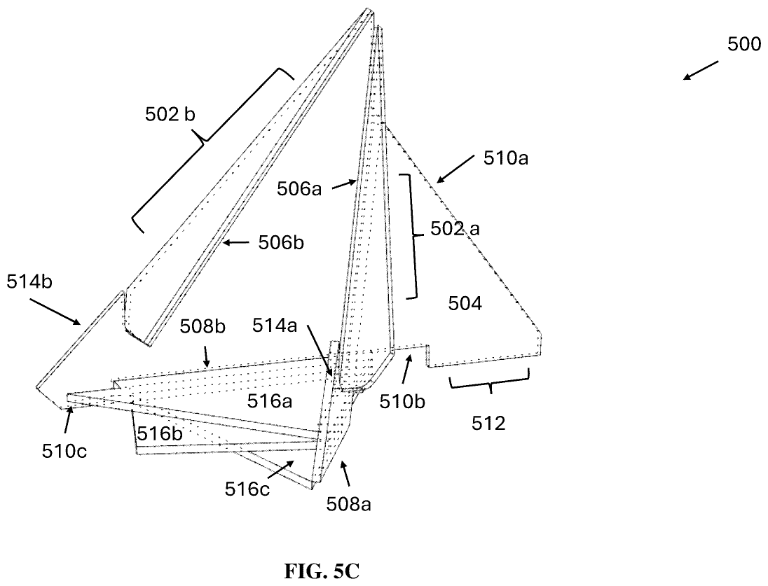

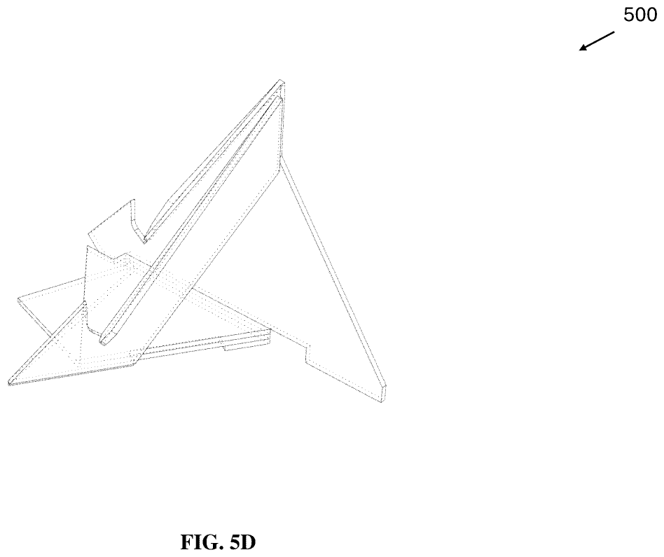

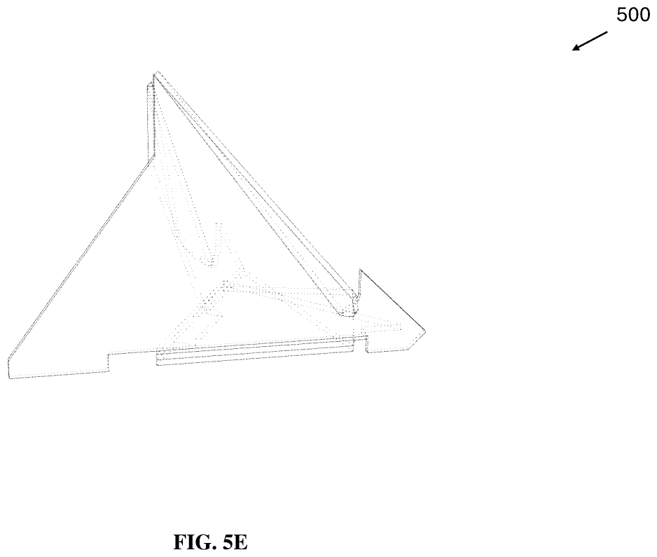

FIG. 5A shows another design 500 in its preliminary flat configuration. The dashed lines 506a 506b 506c represent a score from the top halfway through the material for a mountain fold, the dotted lines 508a 508b 508c 508d represent a score from the bottom halfway through the material for a valley fold, and solid lines 510a 510b 510c 512 514a 514b represent a cut all the way through the material so that the adjoining sections can be separated. Similar to the other designs, the product is assembled by making the appropriate folds along the scores in the material and separating the material at the cuts. When the product, in its preliminary flat orientation, is held along the center of the left edge 502b and the center of the upper edge 502a, and a perpendicular force is applied to the mid-section 504, the product easily folds along the preconfigured scores and cuts in the material such that the mid-section 504 is pushed backwards along the cut portion 510a and is propped up by an outdent 512. The general process and result is shown in FIGS. 5B-5E. FIG. 5B generally shows the assembly process in three stages from left to right: the first stage is the design in its flat orientation; the second stage shows fully folded form; the third stage shows the product in use, with the back of the phone resting against the outer rims 502a 502b and the edge of the phone being held by the hooks 514a 514b such that the phone rests above the triangular base of the holder which is comprised of the three triangular layers 516a 516b 516c (shown in FIG. 5A) folded over each other. FIGS. 5C-5E show the fully assembled design, with FIG. 5C showing a front right view, FIG. 5D showing a right sideview, and FIG. 5E showing a rear left side view.

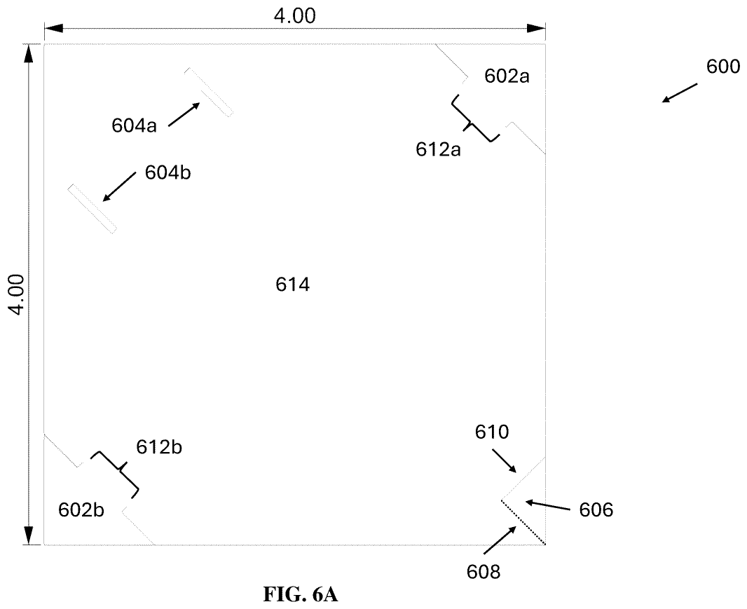

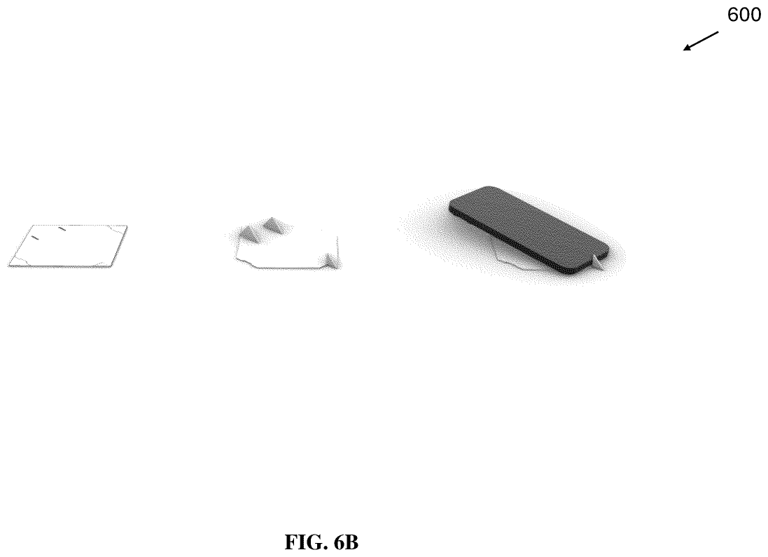

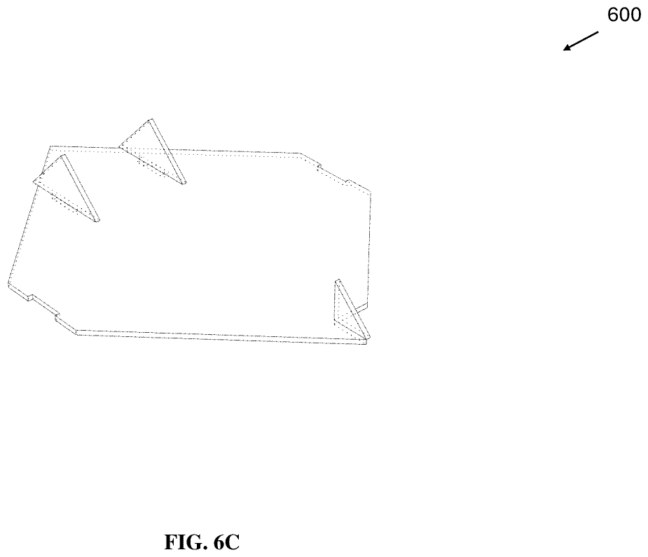

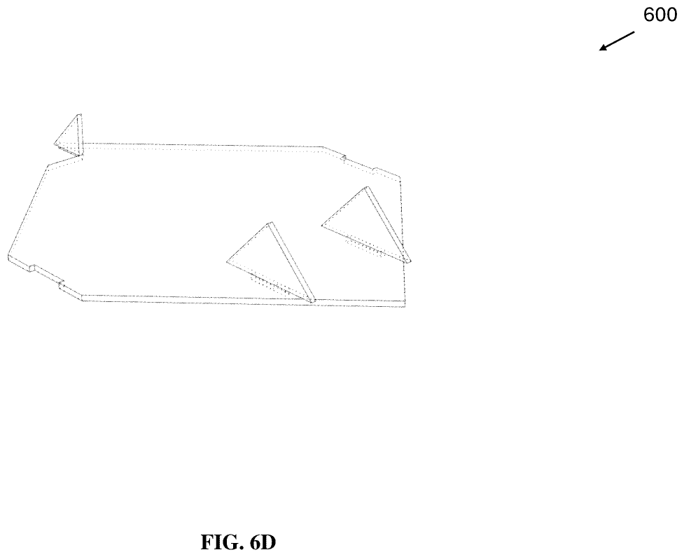

FIG. 6A shows another design 600 in its preliminary flat configuration. The solid lines 602a 602b 604a 604b 610 represent a cut all the way through the material so that the adjoining sections can be separated, and the dotted line 608 represent a score from the bottom halfway through the material for a valley fold. The cuts on the upper right 602a and bottom left 602b corners (represented by solid lines in a triangular shape), allow the outlined sections 602a 602b to be separated from the rest of the material. When both corners are removed, you are left with three separate pieces 602a 602b 614. The cuts in the upper left quadrant (shown by solid lines in the shape of a rectangle 604a 604b) allow for two small rectangular pieces 604a 604b of material outlined by the cuts to be removed and discarded. The two triangular shapes separated from the upper right 602a and bottom left 602b corners both have outdent “tabs” 612a 612b along the edge of the triangle opposite the right angle (the original corner of the square shape prior to separation). These “tabs” 612a 612b are then inserted into the rectangular cutouts 604a 604b in the upper left quadrant. On the lower right corner, a cut 610 (represented by a solid line) running diagonally from the lower right border towards the bottom edge of the square meets a perpendicular score 608 in the material (represented by a dotted line) which runs diagonally from the bottom right corner towards the middle of the square. The bottom right corner 606 is folded upwards (valley fold) along the score 608 (blue line) so that the cut 610 (black line) is separated from its adjoining section 614, and the resulting formation is a small upright triangular piece 606, with the cut edge 610 now facing the upper left corner of the material. FIG. 6B generally shows the assembly process in three stages from left to right: the first stage is the design in its flat orientation; the second stage shows fully assembled form with the outdent “tabs” 612a 612b from the separated triangular portions 602a 602b inserted into the corresponding cutouts 604a 604b in the upper left quadrant and the bottom right corner 606 folded upwards in a valley fold; the third stage shows the product in use, with a phone resting on the points of the two triangular pieces 602a 602b inserted in the cutouts 604a 604b in the upper left quadrant, and the base of the phone resting against the upward folded triangular section 606 in the bottom right corner. FIGS. 6C-6D show the fully assembled design, with FIG. 6C showing a view from the bottom edge, and FIG. 6D showing a view from the upper edge.

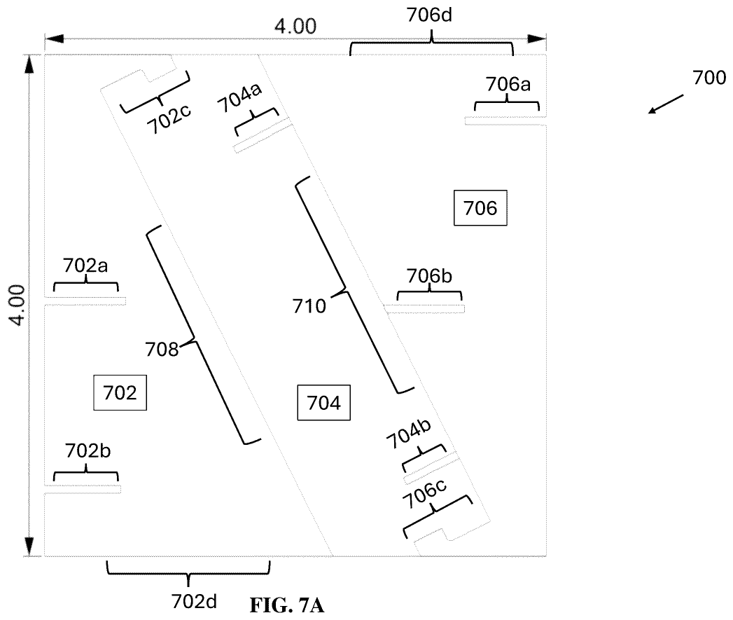

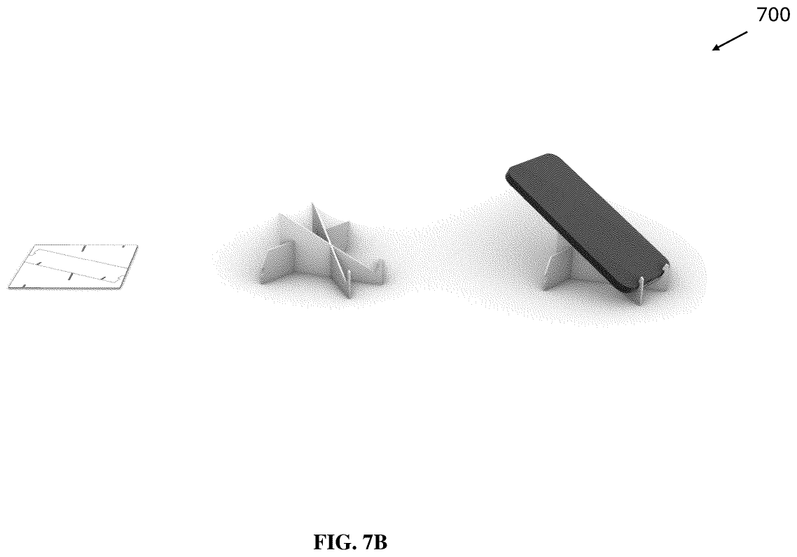

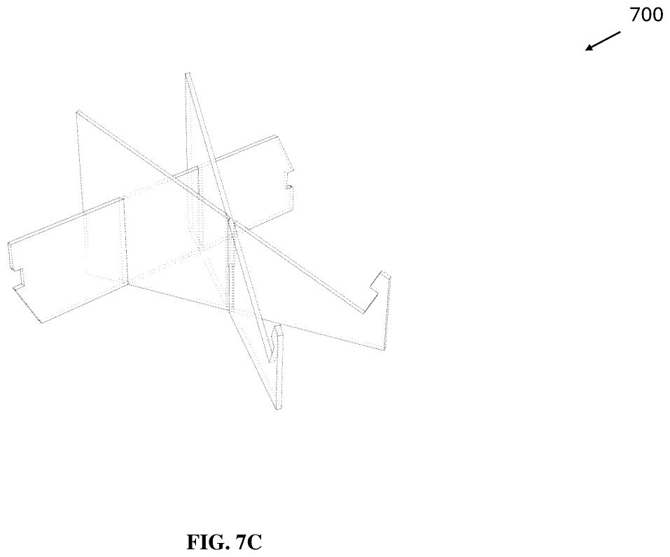

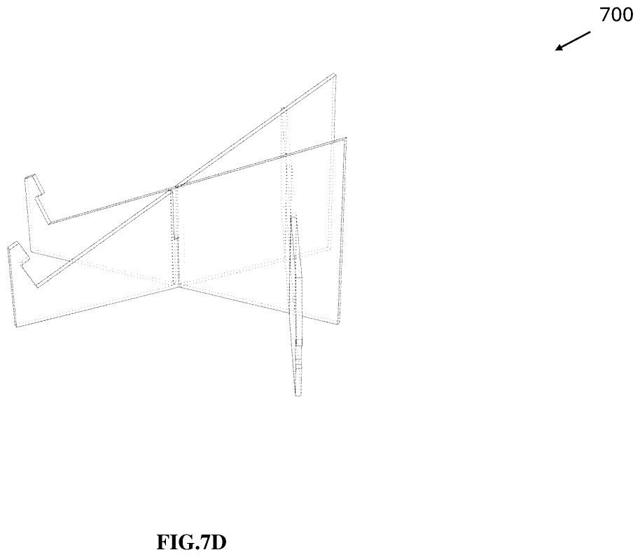

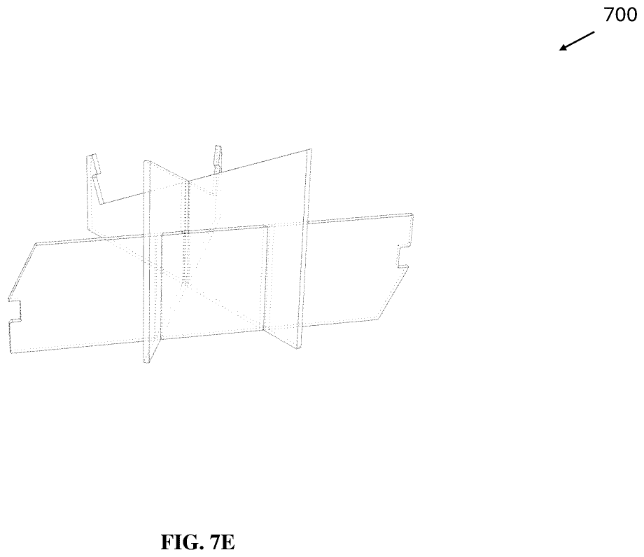

FIG. 7A shows another design 700 in its preliminary flat configuration. The solid lines represent a cut all the way through the material so that the adjoining sections can be separated. The parallel cuts 708 710 running diagonally from the upper left to the lower right quadrant allow for the material to be separated into three parts 702 704 706. The left 702 and right 706 sections, when removed, are somewhat triangular in shape, but have a “hook” like shape 702c 706c in place of a corner opposite the shortest leg 702d 706d of the triangular shape. The left triangular section 702, when looking at FIG. 7A, has a cutout “indent” 702a in the middle of the long side running towards the opposite hypotenuse of the triangle, and the right triangular section has a cutout “indent” 706b in the middle of the hypotenuse running towards the opposite long side of the triangle. When these two triangular sections 702 706 are separated along the cuts 708 710 in the material, they are connected in an “X” shape, with the left triangle 702 above the right triangle 706 so that the cutout “indents” 702a 706b line up, so that the cutout of the left triangle 702a can be inserted down into the cutout of the right triangle 706b. The resulting formation is an “X” shape, with both right angles of the triangular shape forming the top half of the “X”, and the “hooked” ends 702c 706c of both triangular shapes forming the bottom half of the “X”, with the hypotenuse side of both triangles facing upwards. These two triangular pieces both have cutouts 702b 706a along the long side, adjacent to the right angle and opposite the hypotenuse (as seen on the upper right and lower left edge of FIG. 7A). The remaining middle section 704, once the side sections are separated, is rectangular in shape with two cutouts 704a 704b along one of the long sides (the right side in FIG. 7A), which correspond with the cutouts 702b 706a on the triangular portions as seen on the upper right and lower left edge of FIG. 7A. Once the two triangular sections 702 706 are assembled in the “X” formation, the rectangular section 704, with the side with the two cutouts 704a 704b facing upwards, can be inserted up into the corresponding cutouts 702b 706a on the triangular sections 702 706 (now on the bottom of the top half of the “X” shape), to act as a crossbar. The general process and result is shown in FIGS. 7B-7E. FIG. 7B generally shows the assembly process in three stages from left to right: the first stage is the design in its flat orientation; the second stage shows fully assembled form; the third stage shows the product in use, with a phone resting on it. FIGS. 7C-7E show the fully assembled design, with FIG. 7C showing a front left view, FIG. 7D showing a right sideview, and FIG. 7E showing a rear view.

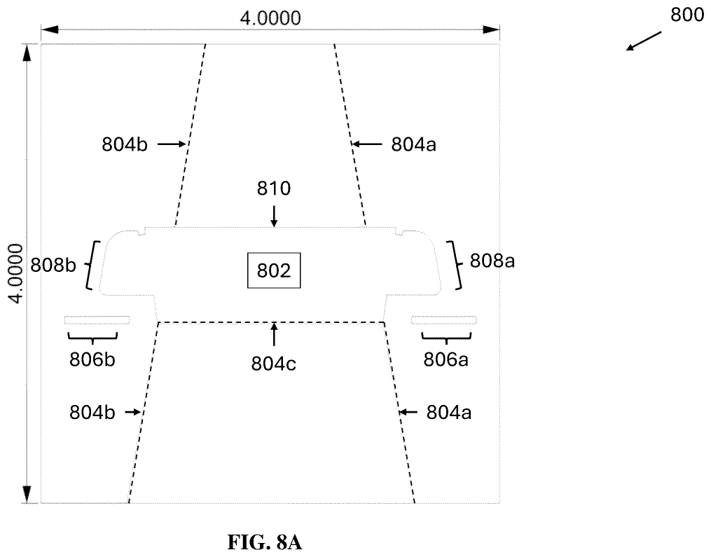

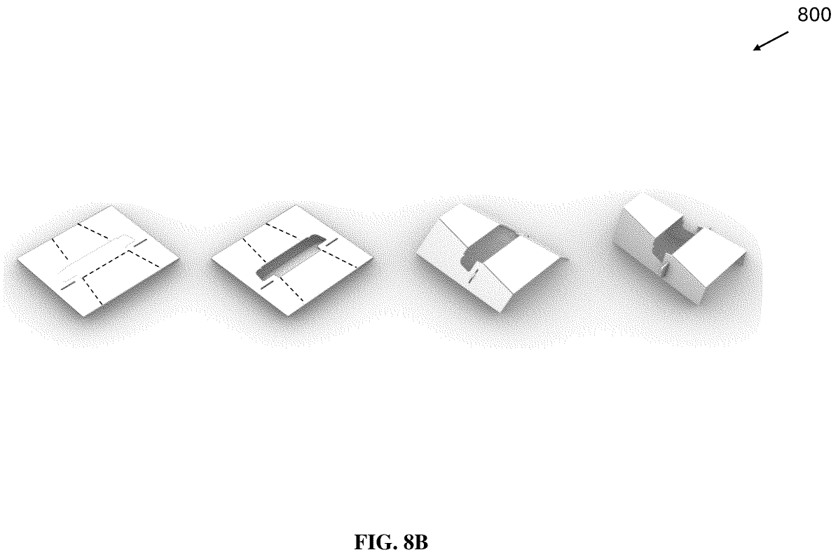

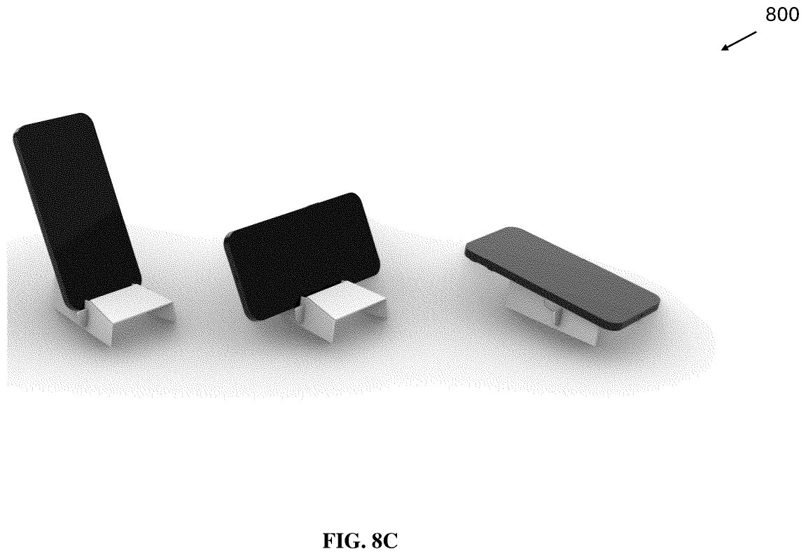

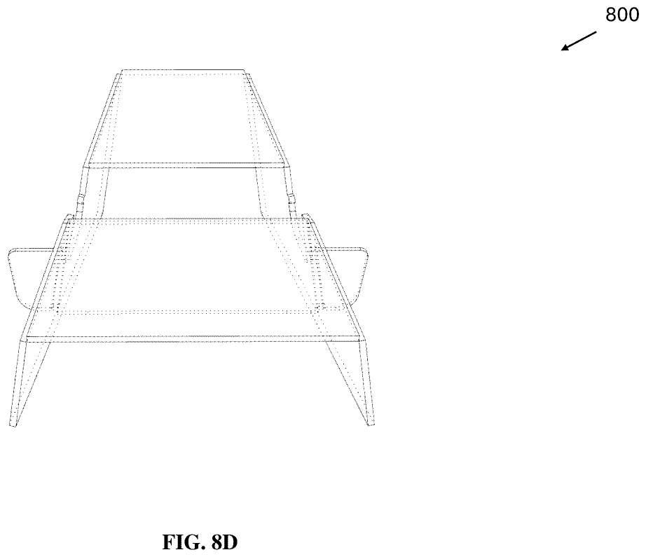

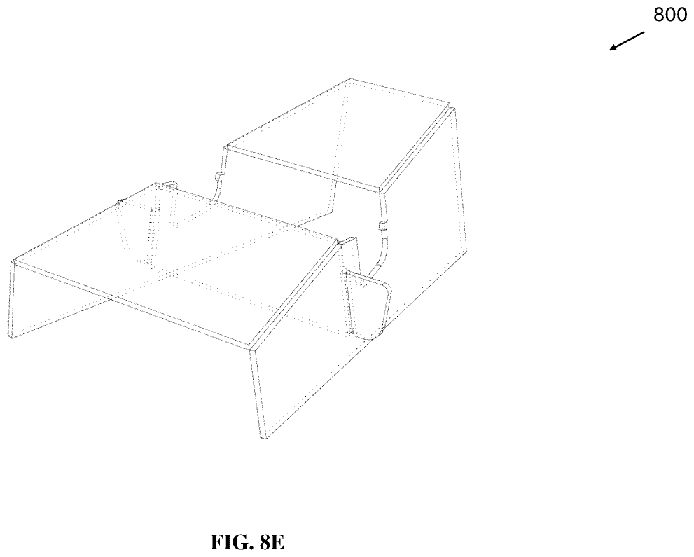

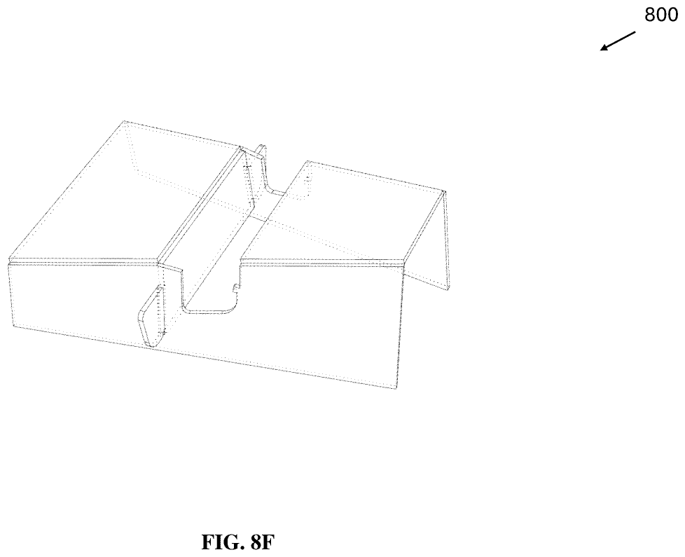

FIG. 8A shows another design 800 in its preliminary flat configuration. The dashed lines 804a 804b 804c represent a score from the top halfway through the material for a mountain fold, and solid lines 806a 806b 808a 808b 810 represent a cut all the way through the material so that the adjoining sections can be separated. The cut in the mid-section (represented by solid lines), allows the outlined section 802 to be pushed back and away from the adjacent portions of the material, but remains connected along the dashed line 804c on the bottom (score for fold). The diverging dashed lines 804a 804b (scores) running from top to bottom indicate where the material is folded in a mountain fold. The cuts in the bottom right 806a and left 806b quadrants (shown by solid lines in the shape of a rectangle) allow for a small piece of material outlined by the cuts to be removed. The outdents 808a 808b on both sides of the cut portion 802 (outlined in solid) in the mid-section line up with the cutout sections 806a 806b in the bottom right and left quadrant of FIG. 8A, so that when the cut section 810 in the mid-section 802 is separated from the adjacent sections and folded back, the outdents 808a 808b line up with the cut-outs 806a 806b in the bottom right and left quadrants when the material is folded along the scores 804a 804b running vertically from top to bottom. Once lined up, the outdent “tabs” 808a 808b are inserted into the cutouts 806a 806b. FIG. 8B generally shows the assembly process in four stages from left to right: the first stage is the design in its flat orientation; the second stage shows the cut portion 802 separated from the adjacent sections; the third stage shows the mountain folds along the dashed lines 804a 804b; the fourth stage shows fully folded form with the outdent “tabs” 808a 808b inserted into the corresponding cutouts 806a 806b. FIG. 8C shows the product in use, with a phone resting on it in a vertical, horizontal, and flat orientation. FIGS. 8D-8F show the fully assembled design, with FIG. 8D showing a front center view, FIG. 8E showing a front right view, and FIG. 8F showing a right side view.

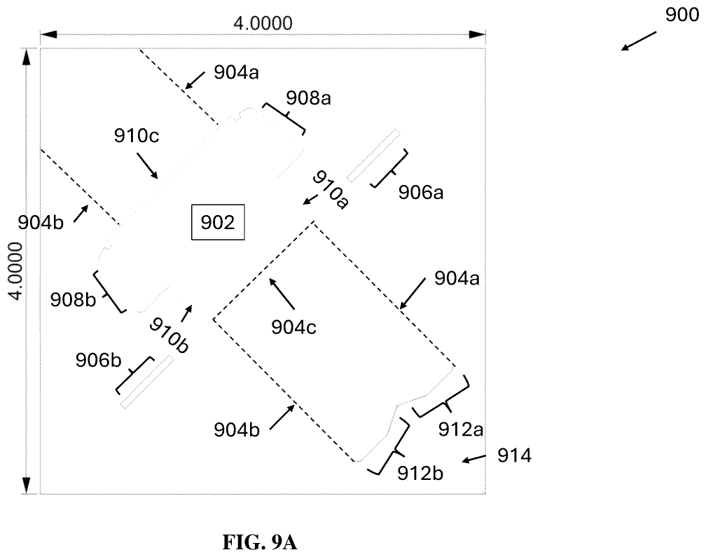

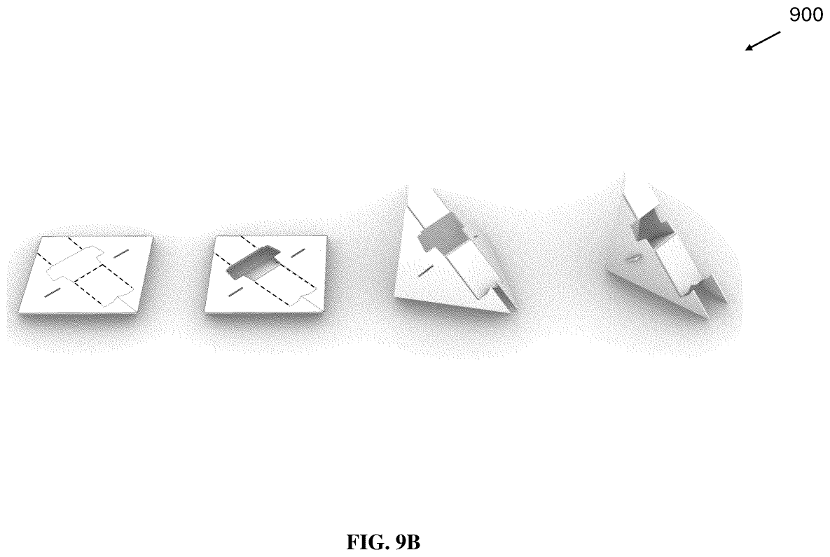

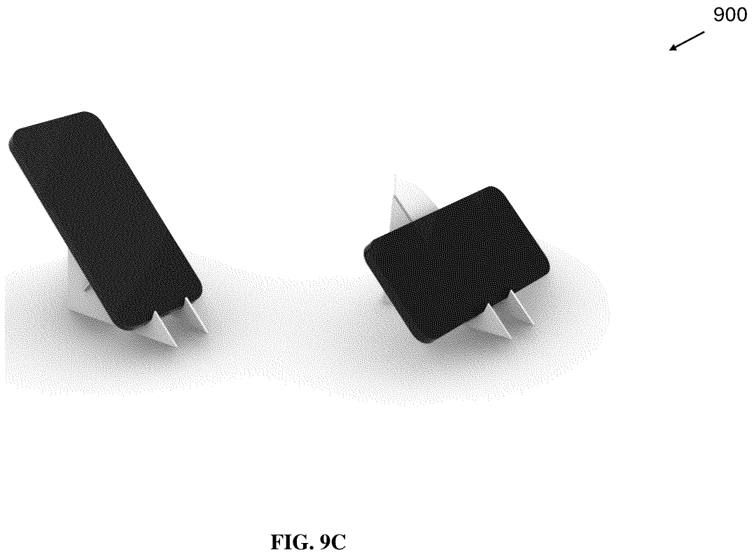

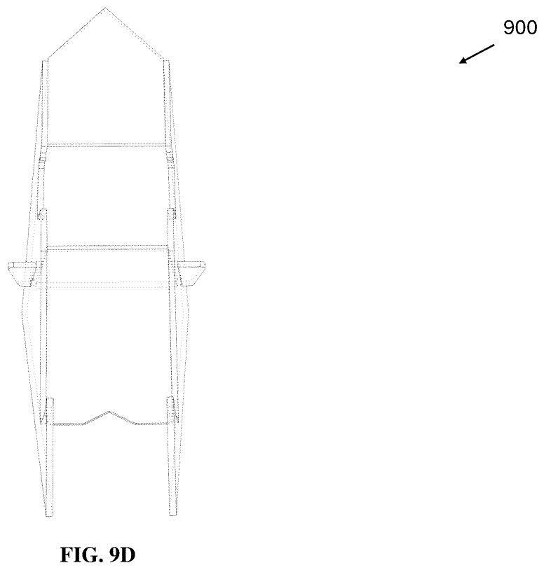

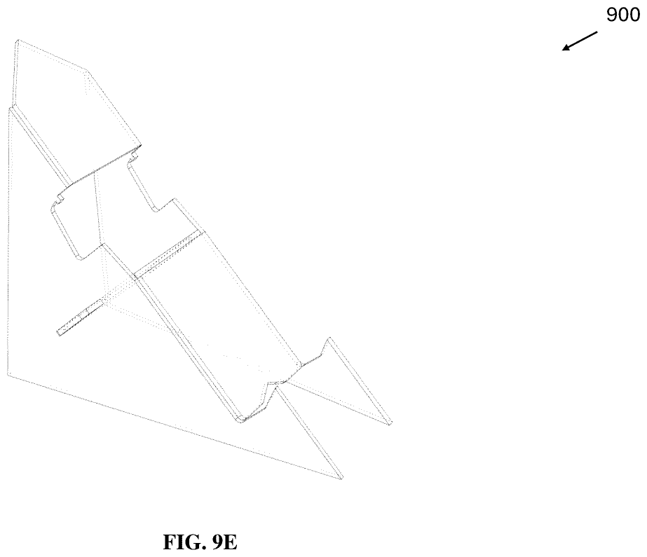

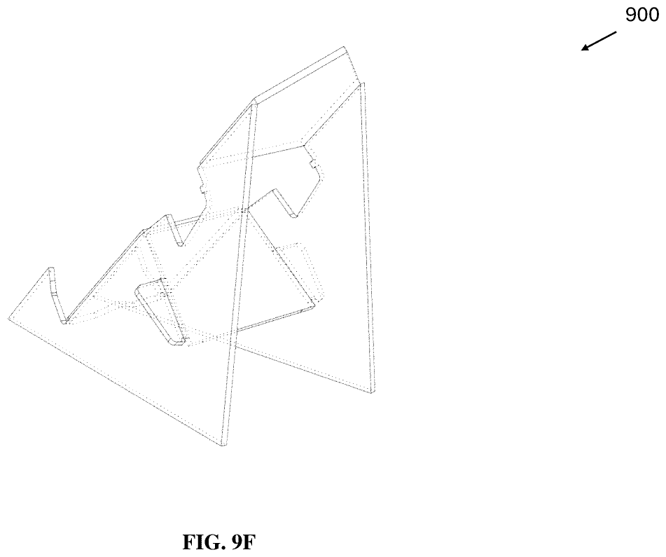

FIG. 9A shows another design 900 in its preliminary flat configuration, similar to that in FIG. 2A with minor modifications. The dashed lines 904a 904b 904c represent a score from the top halfway through the material for a mountain fold, and solid lines 906a 906b 908a 908b 910a 910b 910c 912a 912b 914 represent a cut all the way through the material so that the adjoining sections can be separated. The cuts 910c 908a 908b 910a 910b in the upper left quadrant (represented by solid lines), allows the outlined section 902 to be pushed back and away from the adjacent portions of the material, but remains connected along the dashed line 904c on the bottom portion of the section 902 (scores for folds). The parallel dashed lines 904a 904b (scores) running diagonally from the upper left to the lower right quadrant show where the material is folded in a mountain fold. The cuts in the upper right 906a and lower left 906b quadrants (shown by solid lines in the shape of a rectangle) allow for a small piece of material outlined by the cuts 906a 906b to be removed. The outdents 908a 908b on both sides of the cut portion 902 (outlined in solid) in the upper left quadrant line up with the cutout sections 906a 906b in the upper right and lower left quadrant of FIG. 9A, so that when the cut section 902 in the upper left quadrant is separated from the adjacent sections and folded back, the outdents 908a 908b line up with the cut-outs 906a 906b in the upper right and lower left quadrants when the material is folded along the diagonal scores 904a 904b running from the upper left to bottom right quadrants. Once lined up, the outdent “tabs” 908a 908b are inserted into the cutouts 906a 906b. FIG. 9B generally shows the assembly process in four stages from left to right: the first stage is the design in its flat orientation; the second stage shows the cut portion 902 separated from the adjacent sections; the third stage shows the mountain folds along the dashed lines 904a 904b; the fourth stage shows fully folded form with the outdent “tabs” 908a 908b inserted into the corresponding cutouts 906a 906b. FIG. 9C shows the product in use, with a phone resting on it in a vertical and horizontal orientation, secured by hooked edges 912a 912b. FIGS. 9D-9F show the fully assembled design, with FIG. 9D showing a front view, FIG. 9E showing a left side view, and FIG. 9F showing a rear right side view.

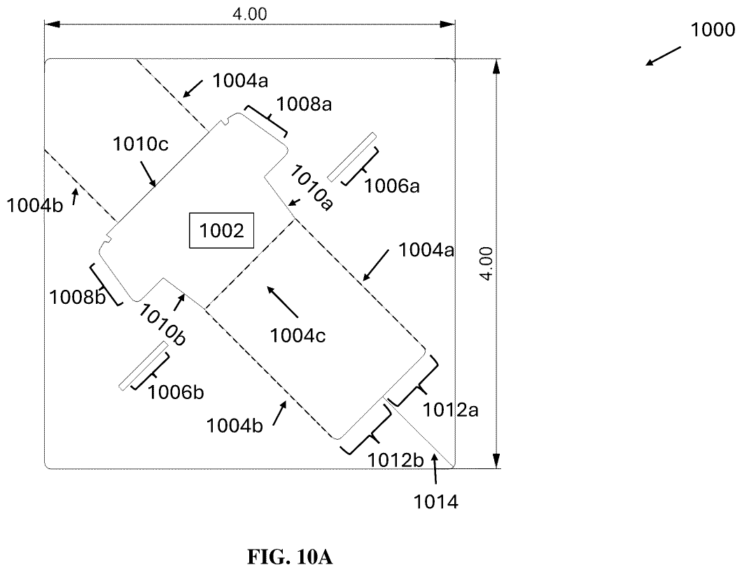

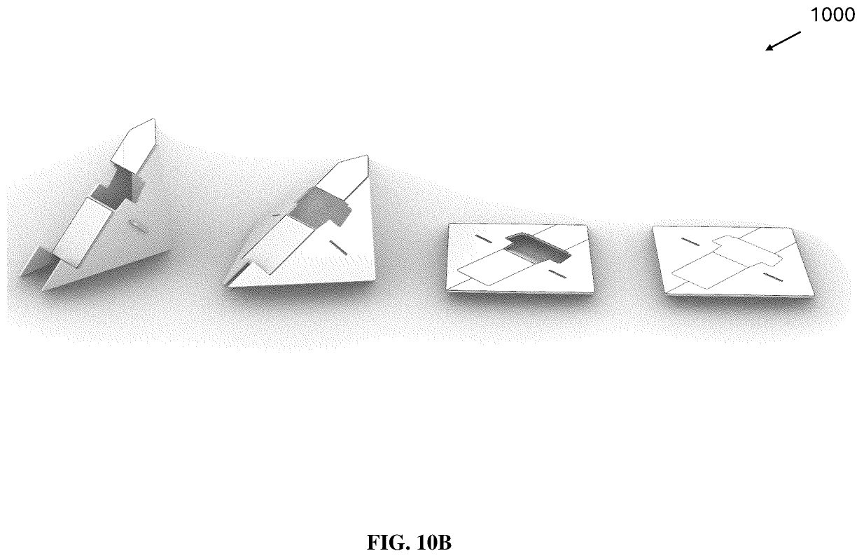

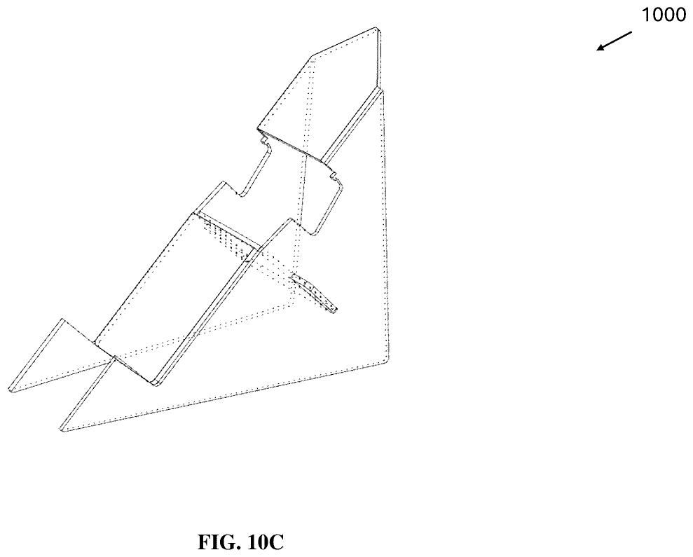

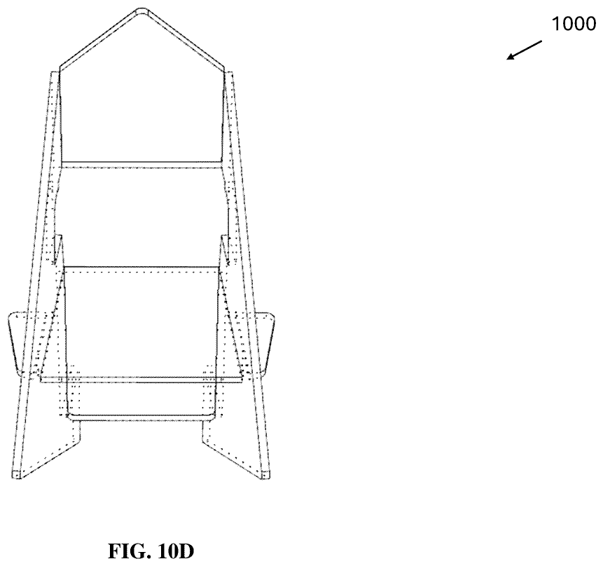

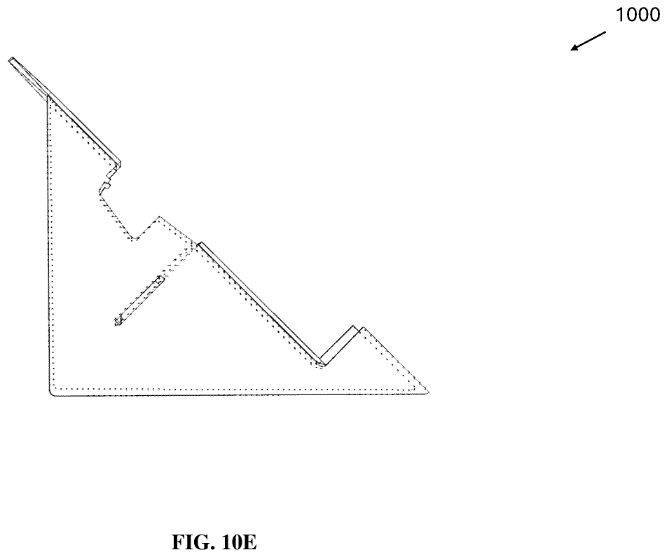

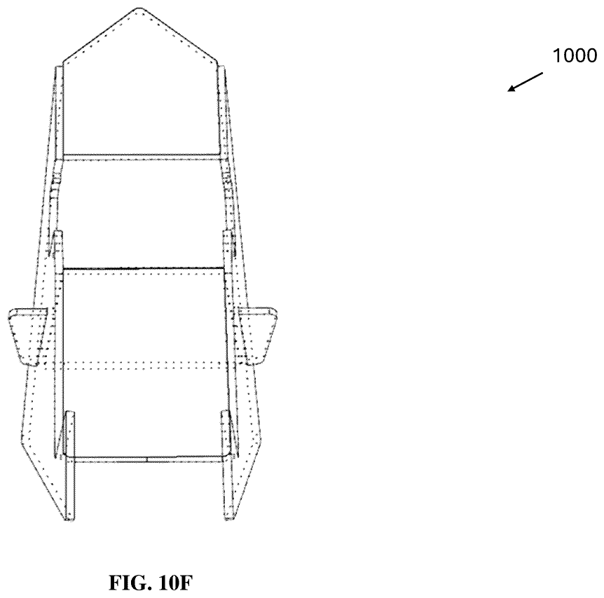

FIG. 10A shows another design 1000 in its preliminary flat configuration, similar to that in FIG. 9A with minor modifications. The dashed lines 1004a 1004b 1004c represent a score from the top halfway through the material for a mountain fold, and solid lines 1006a 1006b 1008a 1008b 1010a 1010b 1010c 1012a 1012b 1014 represent a cut all the way through the material so that the adjoining sections can be separated. The cuts 1010c 1008a 1008b 1010a 1010b in the upper left quadrant (represented by solid lines), allows the outlined section 1002 to be pushed back and away from the adjacent portions of the material, but remains connected along the dashed line 1004c on the bottom portion of the section 1002 (scores for folds). The parallel dashed lines 1004a 1004b (scores) running diagonally from the upper left to the lower right quadrant show where the material is folded in a mountain fold. The cuts in the upper right 1006a and lower left 1006b quadrants (shown by solid lines in the shape of a rectangle) allow for a small piece of material outlined by the cuts 1006a 1006b to be removed. The outdents 1008a 1008b on both sides of the cut portion 1002 (outlined in solid) in the upper left quadrant line up with the cutout sections 1006a 1006b in the upper right and lower left quadrant of FIG. 10A, so that when the cut section 1002 in the upper left quadrant is separated from the adjacent sections and folded back, the outdents 1008a 1008b line up with the cut-outs 1006a 1006b in the upper right and lower left quadrants when the material is folded along the diagonal scores 1004a 1004b running from the upper left to bottom right quadrants.

Once lined up, the outdent “tabs” 1008a 1008b are inserted into the cutouts 1006a 1006b. FIG. 10B generally shows the assembly process in four stages from right to left: the first stage shown on the far right is the design in its flat orientation; the second stage shows the cut portion 1002 separated from the adjacent sections; the third stage shows the mountain folds along the dashed lines 1004a 1004b; the fourth stage on the far left shows fully folded form with the outdent “tabs” 1008a 1008b inserted into the corresponding cutouts 1006a 1006b. FIGS. 10C-10F show the fully assembled design, with FIG. 10C showing a front right view, FIG. 10D showing a rear view, FIG. 10E showing a left side view, and FIG. 10F showing a front view.

Notably, in accordance with the embodiments shown specifically in FIGS. 2A-2E, FIGS. 3A-3D, FIGS. 8A-8F, FIGS. 9A-9F, and FIGS. 10A-10F described above, the present disclosure may therefore illustratively provide specifically for a folding coaster stand for mobile phones that comprises: a base structure of a planar material, the base structure being generally rectangular and having a top surface and a bottom surface; a central portion of the base structure; a push flap of the base structure, the push flap located generally centrally within the base structure, the push flap defined by a first straight score through the top surface of the central portion and a cut through the base structure for a remaining outline of the push flap to allow the push flap to fold away from the top surface and remain attached to the central portion by the bottom surface, the push flap defining first and second locking tabs along opposing sides of the remaining outline; two opposing side upright supports, each defined at least partially by respective second straight scores through the top surface of the central portion, the two opposing side upright supports allowed to fold away from the top surface and remain attached to the central portion by the bottom surface; and two tab-accepting apertures, each of the two tab-accepting apertures defined within a respective side upright support of the two opposing side upright supports and configured to accept and hold a corresponding locking tab of the first and second locking tabs of the push flap; wherein folding down the push flap and the two opposing side upright supports allows the first and second locking tabs to be lockingly inserted respectively into the two tab-accepting apertures to transform the base structure of a planar material into a stable standing three-dimensional orientation that inclines the central portion of the base structure to support a mobile phone at a maintained angle of display.

In one embodiment as described above, the base structure is generally square, and wherein the respective second straight scores are generally parallel to each other and extend generally diagonally from one respective side of the base structure toward a respective adjacent side of the base structure. In one of these embodiments as described above, the respective second straight scores extend generally diagonally from one respective side of the base structure toward a respective adjacent side of the base structure and having respective stop points equally short of reaching the respective adjacent side, the two opposing side upright supports each defined further by a first cut between the respective stop points, and a second cut from a corresponding corner of the base structure toward a center of the second cut, wherein the second cut of the two opposing side upright supports form a two-piece support base for the mobile phone when in the stable standing three-dimensional orientation. In one of these embodiments as described above, the second cut comprises an upwardly directed feature away from the corresponding corner of the base structure to create upward lips on the two-piece support base.

In one embodiment as described above, the base structure of the planar material is less than ¼-inch thick.

In one embodiment as described above, the base structure is generally rectangular with pairs of sides being between three to six inches.

In one embodiment as described above, the first and second locking tabs have one or more squared corners.

In one embodiment as described above, the first and second locking tabs have one or more curved corners.

In one embodiment as described above, the first and second locking tabs have locking detents.

In one embodiment as described above, the two opposing side upright supports are substantially vertical when in the stable standing three-dimensional orientation.

In one embodiment as described above, the two opposing side upright supports are angled slightly outwardly when in the stable standing three-dimensional orientation.

In one embodiment as described above, the respective second straight scores extend from one shared side of the base structure to a shared opposing side, and wherein the central portion of the base structure is defined by the respective second straight scores to be wider at a bottom and narrower at a top.

In one embodiment as described above, the two tab-accepting apertures are filled with inserts of the base structure and defined by a surrounding cut, wherein lockingly inserting the first and second locking tabs into the two tab-accepting apertures requires removing the inserts.

In one embodiment as described above, the base structure of planar material comprises an absorbent coaster material.

In one embodiment as described above, the base structure of planar material is selected from a group consisting of: paper, fiberboard, cardboard, cardstock, plastic, and rubberized materials.

In one embodiment as described above, the central portion of the base structure accommodates both vertical and horizontal orientations of the mobile phone when in the stable standing three-dimensional orientation.

In one embodiment as described above, the base structure of planar material includes one or more pre-applied surface treatments to resist liquids, dirt, and contaminants.

In one embodiment as described above, at least the central portion of the base structure includes one or more anti-slip features to secure the mobile phone in place during use of the folding coaster stand when in the stable standing three-dimensional orientation.

In one embodiment as described above, the stable standing three-dimensional orientation is collapsible back into a planar orientation of the base structure.

Additionally, in accordance with the embodiments shown specifically in FIGS. 2A-2E, FIGS. 3A-3D, FIGS. 8A-8F, FIGS. 9A-9F, and FIGS. 10A-10F described above, the present disclosure may also therefore illustratively provide specifically for a method of making folding coaster stand for mobile phones that comprises: providing a sheet of a planar material, the sheet having a top surface and a bottom surface; and die-cutting the sheet to create: a base structure being generally rectangular and having a central portion; a push flap of the base structure, the push flap located generally centrally within the base structure, the push flap defined by a first straight score through the top surface of the central portion and a cut through the base structure for a remaining outline of the push flap to allow the push flap to fold away from the top surface and remain attached to the central portion by the bottom surface, the push flap defining first and second locking tabs along opposing sides of the remaining outline; two opposing side upright supports, each defined at least partially by respective second straight scores through the top surface of the central portion, the two opposing side upright supports allowed to fold away from the top surface and remain attached to the central portion by the bottom surface; and two tab-accepting apertures, each of the two tab-accepting apertures defined within a respective side upright support of the two opposing side upright supports and configured to accept and hold a corresponding locking tab of the first and second locking tabs of the push flap; wherein folding down the push flap and the two opposing side upright supports allows the first and second locking tabs to be lockingly inserted respectively into the two tab-accepting apertures to transform the base structure of a planar material into a stable standing three-dimensional orientation that inclines the central portion of the base structure to support a mobile phone at a maintained angle of display.

The foregoing description has been directed to specific embodiments. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A folding coaster stand for mobile phones, comprising:
a base structure of a planar material, the base structure being generally rectangular and having a top surface and a bottom surface;
a central portion of the base structure;
a push flap of the base structure, the push flap located generally centrally within the base structure, the push flap defined by a first straight score through the top surface of the central portion and a cut through the base structure for a remaining outline of the push flap to allow the push flap to fold away from the top surface and remain attached to the central portion by the bottom surface, the push flap defining first and second locking tabs along opposing sides of the remaining outline;
two opposing side upright supports, each defined at least partially by respective second straight scores through the top surface of the central portion, the two opposing side upright supports allowed to fold away from the top surface and remain attached to the central portion by the bottom surface; and
two tab-accepting apertures, each of the two tab-accepting apertures defined within a respective side upright support of the two opposing side upright supports and configured to accept and hold a corresponding locking tab of the first and second locking tabs of the push flap;
wherein folding down the push flap and the two opposing side upright supports allows the first and second locking tabs to be lockingly inserted respectively into the two tab-accepting apertures to transform the base structure of a planar material into a stable standing three-dimensional orientation that inclines the central portion of the base structure to support a mobile phone at a maintained angle of display.

2. The folding coaster stand as in claim 1, wherein the base structure is generally square, and wherein the respective second straight scores are generally parallel to each other and extend generally diagonally from one respective side of the base structure toward a respective adjacent side of the base structure.

3. The folding coaster stand as in claim 2, wherein the respective second straight scores extend generally diagonally from one respective side of the base structure toward a respective adjacent side of the base structure and having respective stop points equally short of reaching the respective adjacent side, the two opposing side upright supports each defined further by a first cut between the respective stop points, and a second cut from a corresponding corner of the base structure toward a center of the second cut, wherein the second cut of the two opposing side upright supports form a two-piece support base for the mobile phone when in the stable standing three-dimensional orientation.

4. The folding coaster stand as in claim 3, wherein the second cut comprises an upwardly directed feature away from the corresponding corner of the base structure to create upward lips on the two-piece support base.

5. The folding coaster stand as in claim 1, wherein the base structure of the planar material is less than ¼-inch thick.

6. The folding coaster stand as in claim 1, wherein the base structure is generally rectangular with pairs of sides being between three to six inches.

7. The folding coaster stand as in claim 1, wherein the first and second locking tabs have one or more squared corners.

8. The folding coaster stand as in claim 1, wherein the first and second locking tabs have one or more curved corners.

9. The folding coaster stand as in claim 1, wherein the first and second locking tabs have locking detents.

10. The folding coaster stand as in claim 1, wherein the two opposing side upright supports are substantially vertical when in the stable standing three-dimensional orientation.

11. The folding coaster stand as in claim 1, wherein the two opposing side upright supports are angled slightly outwardly when in the stable standing three-dimensional orientation.

12. The folding coaster stand as in claim 1, wherein the respective second straight scores extend from one shared side of the base structure to a shared opposing side, and wherein the central portion of the base structure is defined by the respective second straight scores to be wider at a bottom and narrower at a top.

13. The folding coaster stand as in claim 1, wherein the two tab-accepting apertures are filled with inserts of the base structure and defined by a surrounding cut, wherein lockingly inserting the first and second locking tabs into the two tab-accepting apertures requires removing the inserts.

14. The folding coaster stand as in claim 1, wherein the base structure of planar material comprises an absorbent coaster material.

15. The folding coaster stand as in claim 1, wherein the base structure of planar material is selected from a group consisting of: paper, fiberboard, cardboard, cardstock, plastic, and rubberized materials.

16. The folding coaster stand as in claim 1, wherein the central portion of the base structure accommodates both vertical and horizontal orientations of the mobile phone when in the stable standing three-dimensional orientation.

17. The folding coaster stand as in claim 1, wherein the base structure of planar material includes one or more pre-applied surface treatments to resist liquids, dirt, and contaminants.

18. The folding coaster stand as in claim 1, wherein at least the central portion of the base structure includes one or more anti-slip features to secure the mobile phone in place during use of the folding coaster stand when in the stable standing three-dimensional orientation.

19. The folding coaster stand as in claim 1, wherein the stable standing three-dimensional orientation is collapsible back into a planar orientation of the base structure.

20. A method of making a folding coaster stand for mobile phones, the method comprising:
providing a sheet of a planar material, the sheet having a top surface and a bottom surface; and
die-cutting the sheet to create:
a base structure being generally rectangular and having a central portion;
a push flap of the base structure, the push flap located generally centrally within the base structure, the push flap defined by a first straight score through the top surface of the central portion and a cut through the base structure for a remaining outline of the push flap to allow the push flap to fold away from the top surface and remain attached to the central portion by the bottom surface, the push flap defining first and second locking tabs along opposing sides of the remaining outline;
two opposing side upright supports, each defined at least partially by respective second straight scores through the top surface of the central portion, the two opposing side upright supports allowed to fold away from the top surface and remain attached to the central portion by the bottom surface; and
two tab-accepting apertures, each of the two tab-accepting apertures defined within a respective side upright support of the two opposing side upright supports and configured to accept and hold a corresponding locking tab of the first and second locking tabs of the push flap;
wherein folding down the push flap and the two opposing side upright supports allows the first and second locking tabs to be lockingly inserted respectively into the two tab-accepting apertures to transform the base structure of a planar material into a stable standing three-dimensional orientation that inclines the central portion of the base structure to support a mobile phone at a maintained angle of display.
